(19) United States
(12) Patent Application Publication
(10) Pub. No.: US 2013/0326361 A1
(43) Pub. Date: Dec. 5, 2013

(54) SYSTEM AND METHOD FOR MANAGING MOBILE MULTIMEDIA MESSAGES

(71) Applicant: EyeSay, LLC, San Francisco, CA (US)

(72) Inventor: Dorian Kendal, San Francisco, CA (US)

(73) Assignee: EyeSay, LLC, San Francisco, CA (US)

(21) Appl. No.: 13/902,531

(22) Filed: May 24, 2013

Related U.S. Application Data
(60) Provisional application No. 61/655,376, filed on Jun. 4, 2012.
(60) Provisional application No. 61/682,032, filed on Aug. 10, 2012.

(51) Int. Cl. H04L 12/58; G06F 3/0484

(52) U.S. Cl. CPC H04L 51/066; G06F 3/04842
USPC 715/748; 709/206

(57) ABSTRACT

A mobile application in communication with a mobile message server is disclosed. The mobile application enables users to have a conversation utilizing a media format selected from at least video and audio based on sensor feeds from a mobile device. Configurable tiles of message destinations is overlaid over a recorded message for a user to select. The mobile message server stores each media message for streaming to mobile devices. Conversion and reformatting of the media messages may be performed prior to streaming.

### CROSS-REFERENCE TO RELATED APPLICATION

This application claims the benefit of U.S. Provisional Patent Application Ser. No. 61/682,032 filed Aug. 10, 2012, and the subject matter thereof is incorporated herein by reference in its entirety. This application also claims the benefit of U.S. Provisional Patent Application Ser. No. 61/655,376 filed Jun. 4, 2012, and the subject matter thereof is incorporated herein by reference in its entirety.

### FIELD OF INVENTION

The present disclosure relates to systems and methods for sending mobile messages, and more particularly to a system and method for operating a mobile message system for managing mobile multimedia messages.

### BACKGROUND

With the increased popularity of mobile phones and especially mobile smart phones, texting has become one of the prevalent ways for people to communicate with one another. Mobile text messages are often preferred for its simplicity. Further, mobile text messages are preferred because unlike normal phone calls, a mobile text message can be sent to multiple people at the same time. Even if a mobile text message is not sent to multiple people at the same time, users can enjoy multiple conversations simultaneously when they are text messaging. This is usually more difficult in a phone conversion or when talking in person.

However, despite the benefits of text messaging, users have found that text messages are impersonal and lack a genuine human touch. Users find that text messages often cannot fully communicate a thought that need to be communicated through non-literal means.

Some users began using the Multimedia Messaging Service (MMS), but finds that such service is expensive and inconvenient. MMS often run into compatibility issues and file format issues. Hence, there is still a need to find a mobile messaging solution that can capture non-literal meanings of human interaction. Solutions to these problems have been sought out but no prior development has led to a viable solution.

### BRIEF DESCRIPTION OF THE DRAWINGS

FIG. 1 illustrates a mobile message system, in accordance with an embodiment of the invention.

FIG. 2 a block diagram of modules of the mobile message system 100 as implemented on the mobile device and the message server.

FIG. 3 illustrates an example of an interface provided by the sender module.

FIG. 4 is a flow chart of a method of operating a mobile device through a mobile application to send a media message.

FIG. 5 is a flow chart of a method of operating a mobile device through a mobile application to reply to a media message.

FIG. 6 is a flow chart of a method of operating a message server in communication with a mobile application.

FIG. 7 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

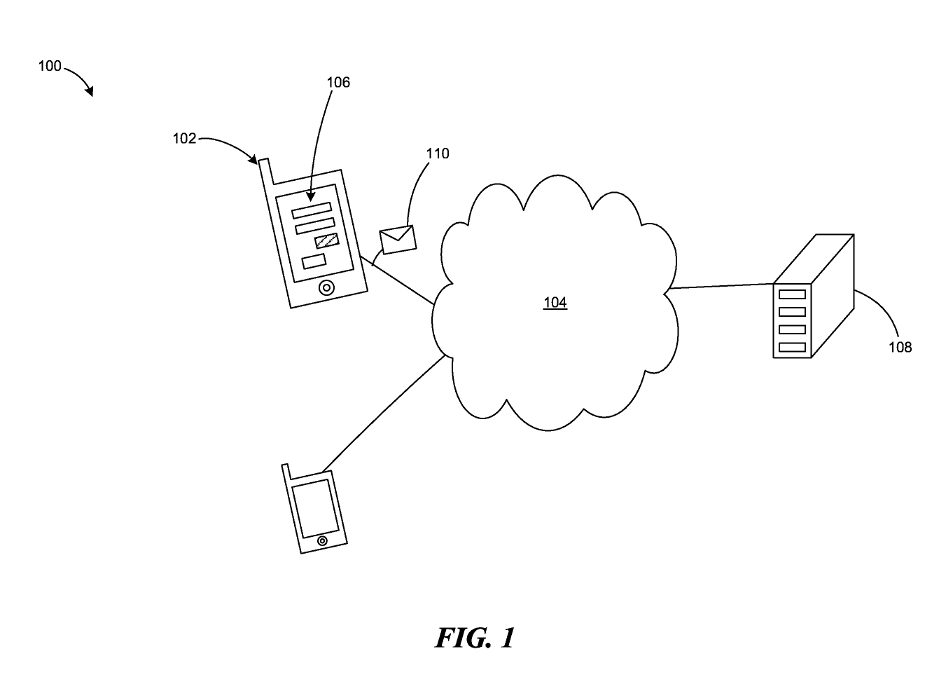

Embodiments of the present disclosure include systems and methods for operating a mobile message system for managing multimedia text messages. A mobile message system 100 is illustrated in FIG. 1. The mobile message system 100 includes a mobile device 102 and a communication channel 104. The mobile device 102 is an active electronic device capable of communicating through the communication channel 104. For example, the mobile device 102 can be a smart phone, a tablet, an e-reader, an electronic accessory, a laptop, a computer, or any device with computer functionalities. Each instance of the mobile device 102 can communicate with one or more other instances of the mobile device 102 through the communication channel 104. The communication channel 104 can be a WiFi network, a 3G network, a GSM cellular network, a 4G network, other cellular network, or other wireless Internet connection channels.

The mobile message system 100 can include a mobile application 106 that is available on a variety of mobile operating systems, including but not limited to the iOS and the Android platforms. The mobile application 106 allows individuals to quickly and easily send multimedia messages to a friend, a group of friends, a colleague, a professional group, a corporate entity, a media storage destination, a social networking destination, a website, or any combination thereof. Messages become part of conversations that can be replayed at a later time (both sent and received messages).

The mobile application 106 can be downloaded over the communication channel 104, such as from an application store, a website for the mobile application 106, or via a text message link sent from another user of the mobile message system 100. The mobile device 102 can include a memory for storing the mobile application 106, one or more processors to execute the mobile application 106, and one or more sensors and output devices to implement an interface provided by the mobile application 106.

When a video or message is sent to a user who does not have the mobile application 106, a link to download the mobile application will be sent to them instead, indicating that the mobile application 106 should be downloaded to retrieve their message. The mobile application 106 can serve as an interface between the user and a message server 108. The mobile application 106 can provide a user interface through the mobile device 102, receiving commands and inputs, such as through the mobile device keyboard or touch screen. The commands and inputs can be received through use of a touch screen reading swipes, gestures, button presses, object placement, or any combination thereof.

A user referred to herein is an account that identifies an operator of the mobile application 106. The user account may be logged in through different devices including one or more instances of the mobile device 102.

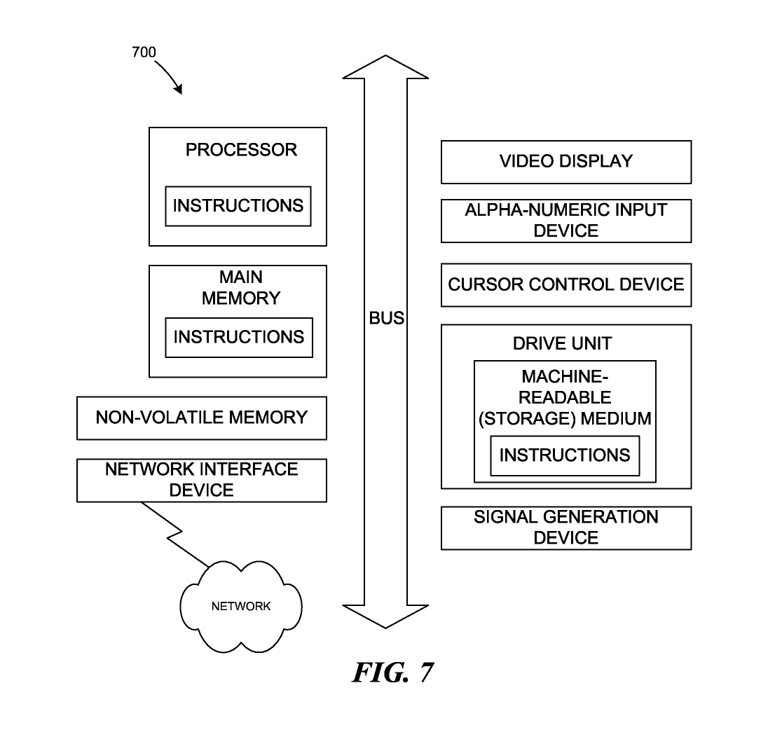

The mobile message system 100 can also include the message server 108. The message server 108 may be implemented by a computer system, such as the computer system 700 described in FIG. 7. The message server 108 can communicate with the mobile application 106 on the mobile device 102 via the communication channel 104. The message server 108 can serve as a relay point for a media message 110 sent between instances of the mobile device 102. The message server 108 can also maintain a database of users of the mobile message system 100. The media message 110 can be, for example, a voice recording, a video recording, a gesture recording, other sensor recordings, a text message, or any combination thereof. The media message 110 can be captured and recorded when the user initiates the media message 110 to be sent via the mobile application 106.

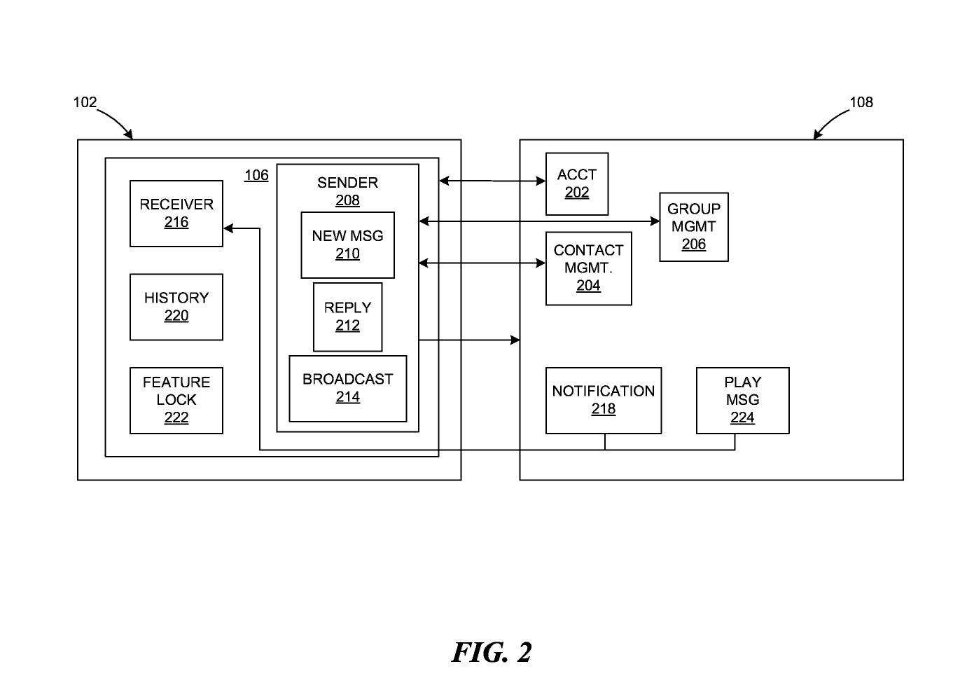

FIG. 2 illustrates a block diagram of modules of the mobile message system 100 as implemented on the mobile device 102 and the message server 108. The mobile device 102 can include one or more methods of sending and receiving the media message 110, such as voice and video messages and managing user messages and user account. The one or more methods can be implemented by modules described below.

The modules can be implemented as a hardware module, a software module, or any combination thereof. For example, the modules described can be software modules implemented as instructions on a storage memory capable of being executed by a processor or a controller on the mobile device 102 or the message server 108.

Each of the modules may operate individually and independently of other modules. Some or all of the modules may be executed on the same host device or on separate devices. The separate devices can be coupled via a communication module to coordinate its operations. Some or all of the modules may be combined as one module. A single module may also be divided into sub-modules, each sub-module performing separate method step or method steps of the single module. The modules can share access to a memory space. One module may access data accessed by or transformed by another module. The modules may be considered “coupled” to one another if they share a physical connection or a virtual connection, directly or indirectly, allowing data accessed or modified from one module to be accessed in another module.

The mobile device 102 can include additional, fewer, or different modules for various applications. The message server 108 can include additional, fewer, or different modules for various applications. Conventional components such as network interfaces, security functions, load balancers, failover servers, management and network operations consoles, and the like are not shown so as to not obscure the details of the system

The message server 108 can include an account module 202. The account module 202 is for receiving and storing account entries associated with a user account. The account entries can be received during a registration process or after an account has been established on the message server 108.

The message server 108 can interact with the mobile application 106 to receive the account entries for registration or for account updates. The account module 202 can store the account entries associated with an account name, an account email, an account phone number, account password, contact list, or any combination thereof. The account entries can include user name, user phone number, location information such as country or state, user email address, or any combination thereof. The account entries listed above can be configured to be required for registration. Optionally, the account information can also include a photo of the user.

During the registration process, the message server 108 can send a text message to the mobile device 102 with a validation code. The registration process can be blocked if the validation code is not send back to the message server 108 through the communication channel 104.

The mobile device 102 can receive a text message prompting registration with the message server 108 if the user of the mobile device 102 is a recipient of a media message 110, but is not a registered user on the message server 108. When the user is registering after receiving a text informing the user of a pending media message 110 on the message server 108 to be played, the mobile application 106 can play the media message 110 after the registration or present a link to play the media message 110.

The message server 102 can include a contact management module 204. The contact management module 204 is for managing a list of contacts for the user account to be stored on the message server 108. The contact management module 202 can be activated by a user or can be automatically activated upon launch of the mobile application 106. The contact management module 204 can synchronize contacts upon launch of the mobile application 106. The mobile application 106 can check with the account module 202 on the message server 108 to make sure the contact list is up to date every time the mobile application 106 is launched.

The mobile application 106 can provide an interface for the user of the mobile device 102 to initiate adding a contact. Upon adding the contact, the contact can be saved on the message server 108 via the contact management module 204. The contact may be specified as an individual, a group, or a categorical destination. The categorical destination may be a network address, the website, a digital storage location, social networking site, other websites, or any combination thereof. The mobile application 106 can also provide an interface to open the contact list of a user and edit an existing contact via the contact management module 204. The changes made can be saved on the message server 108. The mobile application 106 can provide an interface to remove an existing contact. For example, the existing contact can be removed through detection of a swipe or other gestures over a displayed name of the contact. The mobile application 106 can further show photos of everyone on the contact list of the user, with the photos downloaded from the message server 108. Every interaction to modify a contact on the message server 108 can be associated with a gesture that is recognizable via one or more sensors of the mobile device 102 including camera or touchscreen.

The message server 108 can include a group management module 206. In some embodiments, the group management module 206 is the same as contact management module 204. The group management module 206 is for managing groups of contacts. The mobile application 106 can interact with the group management module 206 to create, edit, or remove a contact group. The user through the mobile application 106 can view the contact group. The user through the mobile application 106 can add or remove contacts from the contact group. The user through the mobile application 106 can edit or create a name for the contact group. The group management module 206 can store the contact group information sent from the mobile application 106 to the message server 108.

The mobile device 102 through the mobile application 106 can include a sender module 208. The sender module 208 is for creating the media message 110 to be sent to another user operating another instance of the mobile device 102. The sender module 208 can display an interface for the user to create the media message 110.

In one example, the user can select the media message 110 to be voice. The sender module 208 can record a voice message once the user hits a record button. The voice message can serve as the media message 110.

In another example, the user can select the media message 110 to be video. The sender module 208 can record a video message once the user hits a record button. Optionally, the user can see what is being filmed in real-time. The video message can serve as the media message 110. The user can configure the camera and microphone settings via the sender module 208, such as selecting front or back camera. The sensor settings can be automatically configured for clarity, for ease of transmission, or a combination thereof.

The sender module 208 can include a new message module 210. The new message module 210 is for providing an interface for sending a new instance of the media message 110. After recording the media message 110, the user can select recipients either individuals or groups, through the new message module 210. If the recipient device has the mobile application 106 installed, then the name of the recipient is displayed in bold. The media message 110 can be sent to the message server 108 for storage before delivery to the recipient device. The media message 110 can also be posted on the web simultaneously as it is sent to the message server 108. The media message 110 can further be emailed to the recipient simultaneously as it is sent to the message server 108.

The sender module 208 can include a reply module 212. The reply module 212 is for providing an interface for replying to an instance of the media message 110 sent from an individual or a group. The reply individual module 212 works essentially the same as the new message module 210, except that there is no need to select the recipient.

The sender module 208 can also include a broadcast module 214. The broadcast module 214 is for generating media messages to be broadcasted to one or more broadcast destinations. The broadcast module 214 can be for providing media objects to be included in media messages. The providing of the media objects can include creating, generating, recording, presenting, displaying, or any combination. For example, a media object can be recorded by a microphone and/or a webcam on the mobile device 102.

The media objects are defined as any digital content capable of being played or presented by a digital device. For example, the media objects can include an image, a video, an audio file, a presentation, an interactive application, a game, a book, an audio book, a music score, a user profile, a business card, or any combination thereof.

The broadcast destinations are defined as virtual locations to deliver the media objects or the media messages. For example, the broadcast destination can include a social network, a website, a blog, a network address specific to a network protocol such as a file transfer protocol address, an internal corporate wiki, an internal corporate file storage directory, a RSS feed relay server, an email address, an online storage space, a contacts group, an interactive inferface to add contacts or groups, or any combination thereof. As a specific example, the broadcast destinations can include a Facebook™ post, a Facebook™ status update, a MSN Messenger™ status or profile update, an Instagram™ share, a Twitter™ post, a Google™ documents upload, a Picasa™ upload, the groups of contacts retrieved from the group management module 206, the contact email address from the contact management module 204, or any combination thereof.

The broadcast module 214 can present one or more of the media objects on the mobile device 102 including displaying on a screen, playing via a speaker, notifying through a vibration device, or any combination thereof. The broadcast module 214 can display an overlay of icons of the broadcast destinations over the media object. The icons can be in the forms of a button, a tile, a circle, a link, a word, a logo, or any combination thereof. For example, after the user finishes recording a video on an interface of the broadcast module 214, the user can hit an arrow button and the icons can appear. In this example, the user is not taken to another screen. The overlay of the icons can be a dashboard for selecting recipients. Although it has been illustrated that the overlay of icons/tiles are used to configure, specify, and/or select broadcast destinations, the overlay of icons/tiles can also be used to specify whether the message is to be sent on behalf of a group that the sender belongs to, on behalf of a webpage of the sender, or individually by the sender.

The broadcast module 214 can provide a configuration interface to configure which of the broadcast destinations are shown in the overlay of the icons. The configuration interface can specify the layout and order of the overlay of the icons. The configuration interface can further specify the size, form, or degree of transparency of the icons.

The broadcast module 214 can select a specific icon for a specific destination from the icons for the broadcast destinations by a user interaction with the icons on the mobile device. For example, the user can click the specific icon by a touch on a touch screen, a mouse-over click, a voice command selection of the icon, a keyboard selection of the icon, or any combination thereof.

The broadcast module 214 can highlight the specific icon once it is selected. Highlighting can include emphasizing by bolding, changing color of the icon, changing saturation of the icon, displaying a border around the icon, animating the icon, changing the contrast of the icon, or any combination thereof.

The broadcast module 214 can also deselect the specific icon with a user interaction. The user interaction to deselect can be the same user interaction to select the specific icon. The broadcast module 214 can remove the highlighting of the specific icon once it is deselected.

The broadcast module 214 can generate a media message from the media object formatted for the specific destination selected. For example, the media message can be generated to be a Multimedia Messaging Service (MMS), a Twitter™ post message, a Facebook™ post message, a group email, or any combination thereof. The generated media message can include a message for an application programming interface (API) for the broadcast destinations. For example, the broadcast module 214 can format the media message to be understood by the Facebook™ API.

The broadcast module 214 can send the media message generated to the selected specific destination or destinations. The sending can include an email protocol, such as Microsoft Exchange™, POP3, Simple Mail Transfer Protocol (SMTP), or any combination thereof. The sending can also include messaging via the API of the selected specific destination. For example, the broadcast module 214 can send the media message formatted to be understood by the Facebook™ API.

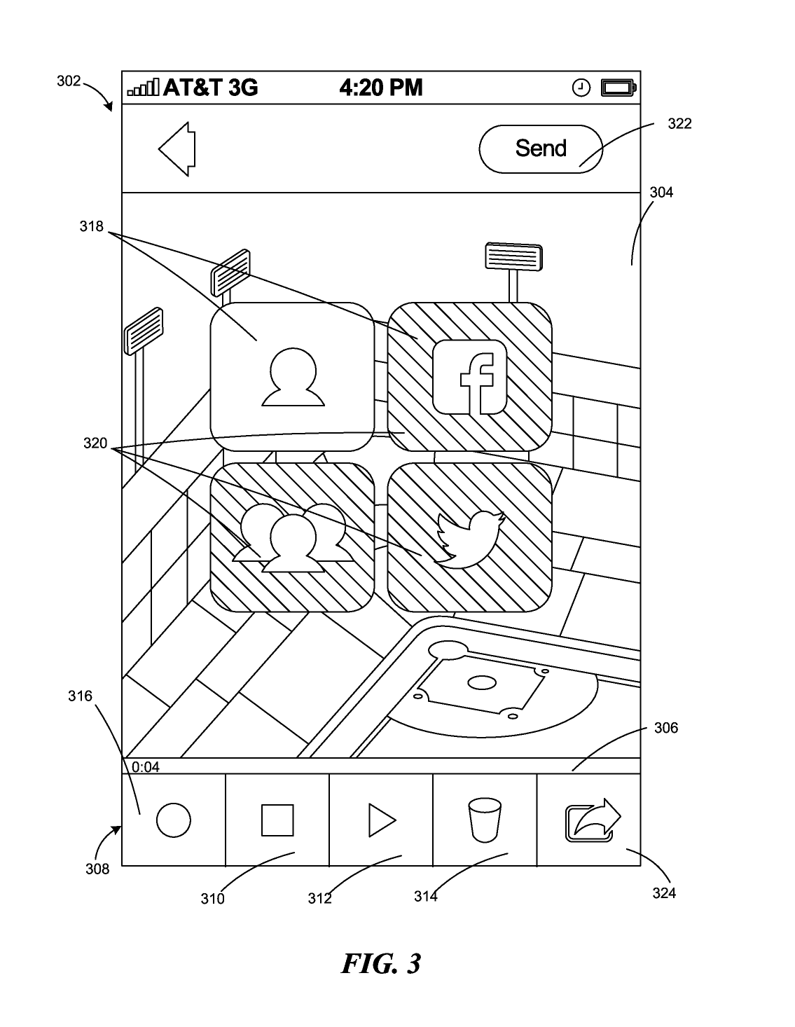

All or parts of the methods steps and functions described for the broadcast module 214 can be implemented on one single interface without the user having to go to a different interface or page. For example, FIG. 3 illustrates an example of such an interface. In one embodiment, the configuration interface, however, can be on a separate screen or interface.

The mobile device 102 through the mobile application 106 can include a receiver module 216. The receiver module 216 is for receiving notification of waiting instances of the media message 110 and for downloading or streaming the media message 110. Upon receiving the notification, the receiver module 216 can alert the user of the mobile device 102 of pending messages. It can be a visual or audio alert. The receiver module 216 can display how many of the waiting instances are voice messages and how many of the waiting instances are video messages.

To listen or watch the media message 110, the user goes to the messages section of the mobile application 106 and picks an instance of the received media message 110. The user can see who sent the media message 110, who it was sent to, the time it was sent, or any combination thereof.

The message server 108 can include a notification module 218. The notification module 218 can send a notification to the mobile application 106 when there are instances of the media message 110 on the message server 108. The notification module 218 can be a push notification that interrupts the mobile device 102 with a pop-up alert or a passive notification that is updated and displayed when the mobile application 106 is launched. When the mobile application 106 is launched and there are new messages already downloaded onto the mobile device 102 or is ready for streaming, a summary of the messages can be directly displayed without the passive notification. The notification can be sent upon when the media message 110 is ready to be played or when the media message is sent.

The mobile device 102 through the mobile application 106 can include a history module 220. The history module 220 can store and retrieve previous conversations for the user of the mobile device 102. The previous conversations are store in the form of a sequence of a plurality of the media message 110.

Although it has been illustrated that the history module 220 is part of the mobile device 102, it is understood that the history module 220 can reside on the message server 108. The history module 220 can store the previous conversations on the non-transitory memory of the message server 108 instead of the non-transitory memory of the mobile device 102.

The mobile device 102 through the mobile application 106 can include a feature lock module 222. The feature lock module 222 can prevent access to certain features of the mobile application 106 when additional payment has not been received. The feature lock module 222 can provide access to those features when the additional payment is received. For example, a “favorites” feature can be locked where, when unlocked, it would provide the user the ability to save favorite conversations on the message server 108 that would not expire. For another example, a “unlimited group size” feature can be locked where, when unlocked, it would provide the user the ability to add an unlimited number of individuals to each contact group. For yet another example, a “download” feature can be locked where, when unlocked, it would provide the user the ability to download the media message 110 and save it on the mobile device 102 for playback.

The message server 108 can include a play message module 224. The receiver module 216 on the mobile device 102 can request the media message 110 from the play message module 224. The play message module 224 can then stream the media message 110 off of the message server 108. Alternatively, the play message module 224 can upload the media message 110 to the mobile device 102 upon receiving the request.

FIG. 3 illustrates an example of an interface 302 provided by the sender module 208 of FIG. 2. Specifically, FIG. 3 can be an example of the interface provided the broadcast module 214 of FIG. 2. The interface can be displayed on a display of a mobile device, such as a touch screen, a liquid crystal display (LCD), an organic light emitting diode (OLED) display, or any combination thereof.

The interface 302 can be for generating a media message from a media object 304. The interface 302 can present the media object 304 on a display. The media object 304 can be a media object as defined above. The media object 304 can be taken or captured real-time. The media object 304 can be downloaded from a portable memory device or over a network, such as a cellular network or a wireless network.

The interface 302 can include a time bar 306. For example, if the media object 304 is a digital object having a time duration, such as an audio stream or a video, then the time bar 306 can represent the entire duration of the media object 304. The time bar 306 can display the total number of seconds or minutes of the media object 304. The time bar 306 can be interactive such that the user can jump to a specific time point on the media object by clicking along the length of the time bar 306.

The interface 302 can include a media panel 308. The media panel 308 is for controlling the creation and presentation of the media object 304. The media panel 308 can include a button 310 to stop playing of the media object 304. The media panel 308 can include a button 312 to start playing the media object 304. The media panel 308 can include a button 314 to delete the media object 304 from memory. The media panel 308 can include a button 316 to re-record the media object 304.

In another embodiment, the button 316 can record an audio segment or a video segment in real-time. The audio or video segment recorded can become the media object 304 or be attached with the media object 304 during the creation of the media message.

The interface 302 can include icons 318, each representing a broadcast destination. The broadcast destination can be locations for sending the media message as defined above. The icons 318 can be highlighted as shown by highlighted icons 320. The icons 318 can be selected and then highlighted by the methods described above.

The interface 302 can include a send button 322. The send button initiates the process of generating the media message from the media object 304 formatted for the broadcast destinations as indicated by the highlighted icons 320. The sender module 208 of FIG. 2, upon generating the media message, can send the media message to the broadcast destinations.

The interface 302 can also include an expand button 324 in the media panel 308. The expand button 324 can activate or execute other functionalities of the interface 302, such as sharing the media object 304, reloading the media object 304, saving the media object 304, copying the media object 304, printing the media object 304, setting the media object 304 as a wallpaper or background music, assigning the media object 304 to be associated with a contact or group, or any combination thereof.

The present invention furnishes many advantages unexpectedly found. For example, it has been unexpectedly found that dynamically recording and sending voice or video messages according to the described methods can create a higher form of communication with non-literal contents fused in a convenient way of communication.

The interface 302 of FIG. 3 has also been discovered to be unique in the ability for the user to pick a whole host of broadcast destinations from one screen, the graphical representation of such items being icons with the flexibility to add, remove, or syndicate icons associated with different broadcast destinations in that one screen.

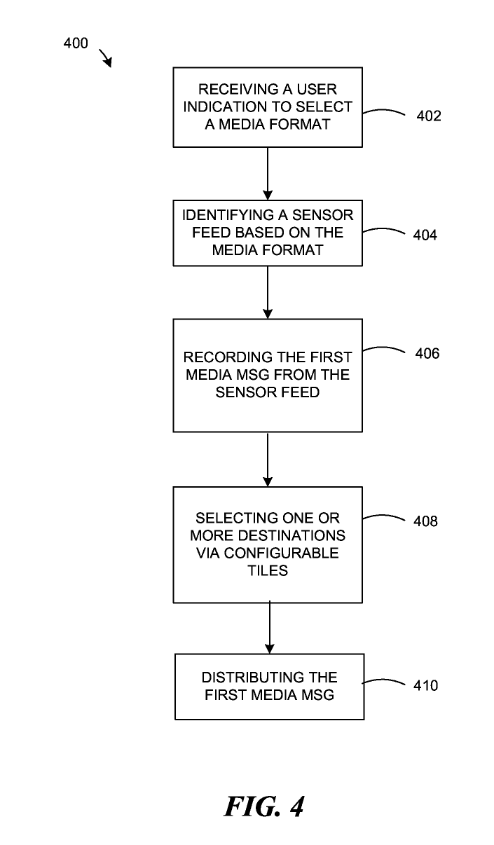

FIG. 4 is a flow chart of a method 400 of operating a mobile device, such as the mobile device 102 of FIG. 1, through a mobile application, such as the mobile application 106 of FIG. 1, to send a media message. The method 400 includes receiving a user indication to select a media format for a first media message in a step 402. The mobile application can then identify a sensor feed based on the media format selected in a step 404. The mobile application records the first media message from the sensor feed for sending in the media format selected in a step 406.

The mobile application then enables the user to select one or more destinations for the first media message via configurable tiles overlay over on a representative display of the first media message in a step 408. Each of the configurable tiles is indicative of a type of destination. In a step 410; the mobile application then distribute the first media message to the one or more destinations. This can be performed either by uploading the first media message to a message server, such as the message server 108, or by transmitting the first media message directly via another native application on the mobile device.

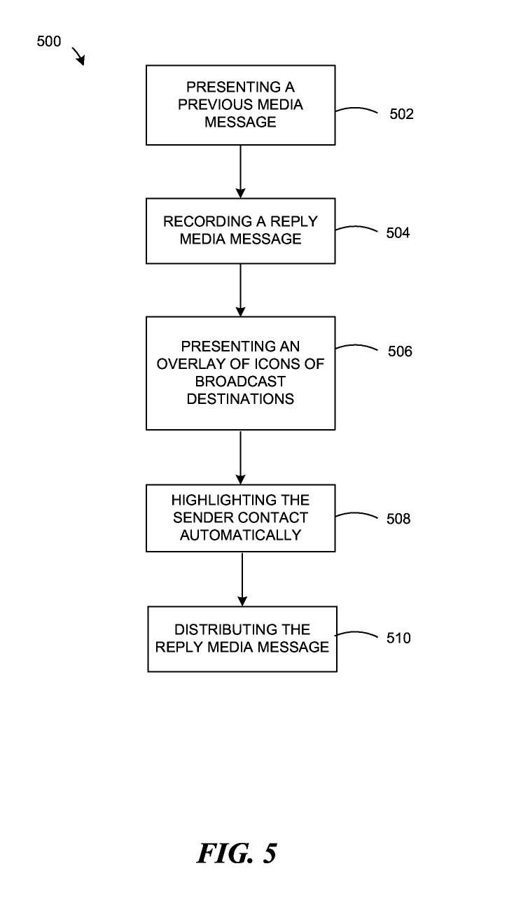

FIG. 5 is a flow chart of a method 500 of operating a mobile device, such as the mobile device 102 of FIG. 1, through a mobile application, such as the mobile application 106 of FIG. 1, to reply to a media message. The method 500 includes presenting a previous media message within a conversation on a mobile device in a step 502. The previous media message may be from at least one sender contact. The user of the mobile application can then choose to record a reply media message in a user specified format in a step 504. After the user-specified format is chosen, an overlay of icons of broadcast destinations is presented over the reply media message in a step 506. One of the icons associated with the sender contact is highlighted automatically in a step 508. The mobile application then distribute the reply media message to specific broadcast destinations associated with highlighted icons in a step 510.

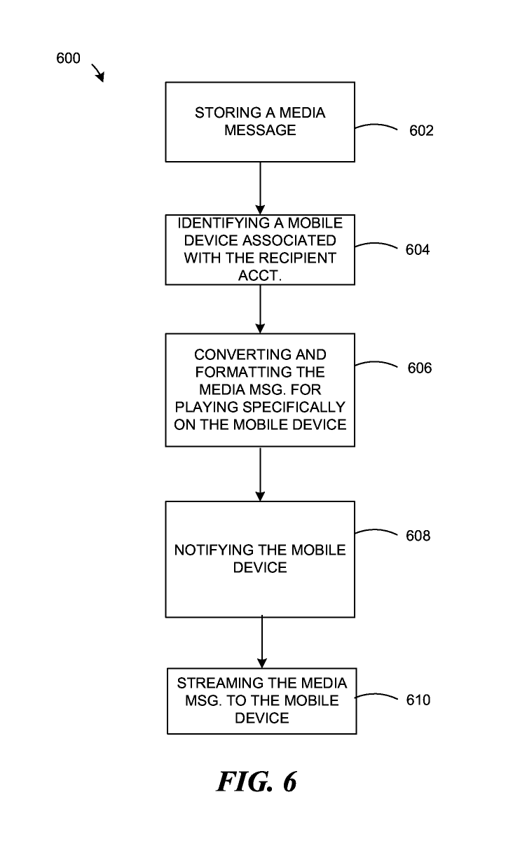

FIG. 6 is a flow chart of a method 600 of operating a message server, such as the message server 108 of FIG. 1, in communication with a mobile message application, such as the mobile application 106 of FIG. 1. The method 600 includes storing a media message uploaded to the message server to be played at a later time in a step 602. The media message is labeled with a destination at a recipient account. The message server then identifies a mobile device associated with the recipient account in a step 604. The message server may then convert and format the media message for playing specifically on the mobile device in a step 606.

At a step 608, the message server notifies the mobile device of the arrival of the media message. At a step 610, the message server streams the media message to the mobile device.

Referring now to FIG. 7, therein is shown a diagrammatic representation of a machine in the example form of a computer system 700 within which a set of instructions, for causing the machine to perform any one or more of the methodologies or modules discussed herein, may be executed.

In the example of FIG. 7, the computer system 700 includes a processor, memory, non-volatile memory, and an interface device. Various common components (e.g., cache memory) are omitted for illustrative simplicity. The computer system 700 is intended to illustrate a hardware device on which any of the components depicted in the example of FIGS. 1-5 (and any other components described in this specification) can be implemented. The computer system 700 can be of any applicable known or convenient type. The components of the computer system 700 can be coupled together via a bus or through some other known or convenient device.

This disclosure contemplates the computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 700. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 700. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 7 reside in the interface.

In operation, the computer system 700 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Those of skill in the art will appreciate that the invention may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative embodiments may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. §112, ¶6 will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of operation of a message server, comprising:
storing a media message uploaded to the message server to be played at a later time, the media message labeled with a destination at a recipient account;
identifying a mobile device associated with the recipient account;
converting and formatting the media message for playing specifically on the mobile device;
notifying the mobile device of the media message; and
streaming the media message to the mobile device.

2. The method of claim 1, further comprising distributing the media message to a network destination via an application interface or a network protocol.

3. The method of claim 1, wherein notifying the mobile device of the media message includes sending a SMS message to the mobile device with a link to stream the media message from the message server.

4. The method of claim 1, wherein storing the media message includes storing the media message in a conversation structure involving a plurality of media objects in different media formats.

5. The method of claim 1, further comprising enabling the mobile device to download the media message when the recipient account is a premium account.

6. A method of operation of a mobile device through a mobile message application to send a media message, comprising:
configuring a plurality of configurable tiles, each tile indicative of an assigned destination or type;
receiving a user indication to select a media format for a first media message;
identifying a sensor feed based on the media format selected;
recording the first media message from the sensor feed for sending in the media format selected;
displaying the plurality of configurable tiles overlaid on a representative display of the first media message;
selecting one or more destinations for the first media message via the configurable tiles; and
distributing the first media message to the one or more destinations.

7. The method of claim 6, wherein distributing the first media message includes opening a native application on the mobile device to deliver the first media message, the native application specific to a network destination of the one or more destinations.

8. The method of claim 6, wherein distributing the first media message includes uploading the first media message to a media message server for streaming to another mobile device; and wherein a completion status of the uploading is displayed.

9. The method of claim 6, further comprising presenting a real-time feedback of the recording of the first media message on the mobile device.

10. The method of claim 6, further comprising requesting a confirmation from a media message server of whether a recipient of the one or more destinations is registered with the media message server when a pre-existing conversation with the recipient is not already cached.

11. The method of claim 6, further comprising configuring a sensor parameter for the recording of the first media message.

12. The method of claim 6, wherein distributing the first media message to the one or more destinations includes sending a SMS text message, containing a link to the mobile message application, to a recipient mobile number associated with one of the one or more destinations, when the recipient mobile number is determined not to be registered with a media message server.

13. The method of claim 6, wherein selecting the one or more destinations includes highlighting the configurable tiles to indicate an associated destination as part of the one or more destinations for the first media message.

14. The method of claim 6, wherein configuring the plurality of configurable tiles includes selecting a network protocol interface to associate with one of the configurable tiles.

15. The method of claim 6, further comprising saving the recorded first media message to a draft cache on the mobile device when the distributing of the first media message is unable to complete immediately subsequent to selecting the one or more destinations.

16. A method of operation of a mobile device to reply to a media message, comprising:
presenting a previous media message within a conversation on the mobile device, the previous media message from at least a sender contact;
recording a reply media message in a user specified format;
presenting an overlay of icons of broadcast destinations over the reply media message;
highlighting an icon associated with the sender contact of the previous media message; and
distributing the reply media message to specific broadcast destinations associated with highlighted icons.

17. The method of claim 16, wherein the previous media message is presented as under a phone number of the sender contact when the sender contact is not present in a contact address book of the mobile device.

18. The method of claim 16, further comprising configuring the icons to select specific broadcast destinations by un-highlighting the icon for the sender contact.

19. A mobile message system comprising:
a storage memory including instructions operable when executed by a processor, the instructions operable to:
configure a plurality of configurable tiles, each tile indicative of an assigned destination or type;
receive a user indication to select a media format for a first media message on a mobile device;
identify a sensor feed based on the media format selected;
record the first media message from the sensor feed for sending in the media format selected;
display the plurality of configurable tiles overlaid on a representative display of the first media message;
select one or more destinations for the first media message via the configurable tiles; and
distribute the first media message to the one or more destinations.

20. The mobile message system of claim 19, wherein the instructions is further operable to:
present a previous media message within a conversation on the mobile device, the previous media message from at least a sender contact;
record a reply media message in a user specified format;
present an overlay of the configurable tiles of the one or more destinations over the reply media message;
highlight one of the configurable tiles associated with the sender contact of the previous media message; and
distribute the reply media message to specific broadcast destinations associated with highlighted configurable tiles.

21. A mobile message system comprising:
a configuration means to configure a plurality of configurable tiles, each tile indicative of an assigned destination or type;
a receiver means to receive a user indication to select a media format for a first media message on a mobile device;
an identification means to identify a sensor feed based on the media format selected;
a recorder means to record the first media message from the sensor feed for sending in the media format selected;
a display means to display the plurality of configurable tiles overlaid on a representative display of the first media message;
a selection means to select one or more destinations for the first media message via the configurable tiles; and
a distribution means to distribute the first media message to the one or more destinations.

22. The mobile message system of claim 21, further comprising:
a conversation presentation means to present a previous media message within a conversation on the mobile device, the previous media message from at least a sender contact;
wherein the recorder means is for recording a reply media message in a user specified format;
wherein the display means is for presenting an overlay of the configurable tiles of the one or more destinations over the reply media message;
wherein the selection means is for highlighting one of the configurable tiles associated with the sender contact of the previous media message; and
wherein the distribution means is for distributing the reply media message to specific broadcast destinations associated with highlighted configurable tiles.
